(19) United States
(12) Patent Application Publication
(10) Pub. No.: US 2010/0314516 A1
(43) Pub. Date: Dec. 16, 2010

(54) EASY RACK DEVICE AND METHOD

(76) Inventor: Thaison Chu, San Ramon, CA (US)

Correspondence Address: ITALIA IP, 3500 WEST OLIVE AVE., SUITE 300, BURBANK, CA, 91505, US

(21) Appl. No.: 12/484,515

(22) Filed: Jun. 15, 2009

(51) Int. Cl. F16M 13/02; B23Q 7/00

(52) U.S. Cl. 248/224.8; 29/559

(57) ABSTRACT

A device for temporarily supporting a component being attached in a rack which has two front vertical corner members and two rear vertical corner members where each front corner member has openings aligned with openings in the opposing rear corner member. Located within the space defined by the four corner members is a support member for holding up the component. A first coupling pin that is supported by a front corner member and an opposing rear corner member on one side of the rack provides support for the support member along a first side. A second coupling pin that is supported by a front corner member and an opposing rear corner member on the other side of the rack provides support for the support member along a second opposite side.

### BACKGROUND

This invention relates generally to an electrical equipment rack mounting device. More specifically, this invention relates to an easy mountable support device and method for holding electronic equipment in place for mounting.

### SUMMARY

Various industries use electrical equipment racks to hold electronic and computer equipment. The racks normally consist of four vertically positioned J shaped channels where each channel is a corner of a square or rectangle. The channels are connected together at their top and bottom ends and attached to the floor and/or ceiling to prevent tipping. The J shaped channels have a web that connects a wide rail to a narrow rail. The wide rails of the J channels are on the front and rear of the rack and the web that connects the wide rail to the narrow rail is on the sides of the rack.

The wide rails of the J channels have threaded openings arranged in a standardized pattern for receiving threaded fastening means which are used to attach a mounting plate of an electronic component to the rack.

During the process of mounting the electronic component to the rack, a person holds and balances the component, which is normally heavy, with one hand while attempting to align a clearance opening in the mounting plate on the electronic component with the threaded opening in the rack. Simultaneously, and while trying to align the two openings by holding the component with only one hand, the person will try to position a screw through the clearance opening and thread the screw into a threaded opening with the fingers on his other hand.

Success with locating and attaching one screw is not the end. He must now go through the same process with a second screw at the other side of the mounting plate of the electronic component before he can consider that the component is fully mounted.

In an embodiment of the invention there is disclosed a device for temporarily supporting a component being attached in a rack which has two front vertical corner members and two rear vertical corner members where each front corner member has openings aligned with openings in the opposing rear corner member. Located within the space defined by the four corner members is a support member for supporting the component. A first coupling pin that is supported by a front corner member and an opposing rear corner member on one side of the rack provides support for the support member along a first side. A second coupling pin that is supported by a front corner member and an opposing rear corner member on the other side of the rack provides support for the support member along a second opposite side.

In another embodiment of the invention there is disclosed a coupling pin for holding a support member to a rack having two front vertical corner members and two rear vertical corner members where each front corner member has openings aligned with openings in each opposing rear corner member. The coupling pin has a long leg that is greater than the distance between opposing front and rear vertical members and has a notch on a side at a first end of the leg adapted to engage a rear corner member when the long leg is located in the aligned openings. A short leg is coupled at an angle to a second end of the long leg.

In another embodiment there is disclosed a method for temporarily supporting a component having a mounting plate with clearance openings that is being installed to a rack having first and second front vertical corner members and first and second rear vertical corner members. The first front member is opposite the first rear member, the second front member is opposite the second rear member, and the front corner members have openings aligned with openings in opposing rear corner member. A support member having a first channel that extends along a first side and a second channel that extends along a second opposing side is placed within the space defined by the four corner members for temporally supporting the component while it is being attached to the rack. A first coupling pin is inserted through an opening in the first front member, through the first channel of the support member and through an aligned opening in the opposing first rear member for supporting the support member along its first side. A second coupling pin is inserted through an opening in the second front member, through the second channel of the support member and through an aligned opening in the opposing second rear member for supporting the support member along its second side. The support member is adapted to temporarily hold the component in position while fasteners are inserted through clearance openings in the mounting plate and aligned openings in the front vertical corner members, after which the first and second coupling pins and the temporary support member are removed from the rack.

In another embodiment there is disclosed a method for holding a support member to a rack that has two front vertical corner members and two rear vertical corner members. Each front corner member has openings aligned with openings in each opposing rear corner member. A coupling pin having a long leg with a length that is greater than the distance between a front and opposing rear vertical member has a notch on a side at a first end which engages a rear corner member when the long leg is in the aligned openings. A short leg is coupled at an angle to a second end of the long leg.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings.

FIG. 1 is a perspective view of a section of a rack to which electrical components are mounted;

FIG. 2 is a top view of a support member in accordance with the principles of the invention;

FIG. 3 is a front end view of the support member of FIG. 2;

FIG. 4A is a side view of an embodiment of a coupling pin for attaching the support member of FIG. 2 to a rack;

FIG. 4B is a side view of another embodiment of a coupling pin for attaching the support member of FIG. 2 to a rack.

FIG. 5 is a top view of the support member attached to a rack with coupling pins; and

FIG. 6 is a front perspective view of a component on a support member that is supported by coupling pins which are removably coupled to openings in the rack as the component is being attached to the rack with screws.

### DETAILED DESCRIPTION

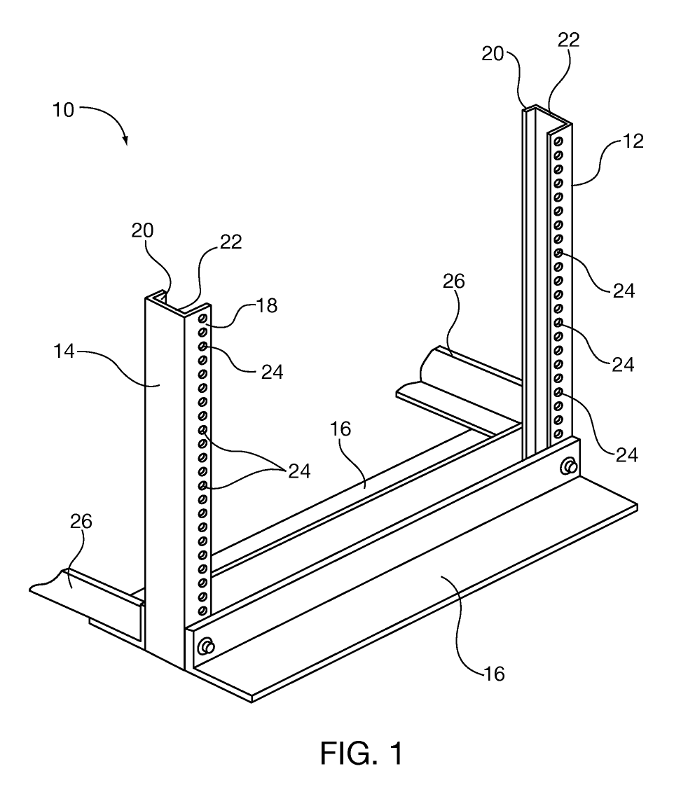

Referring to FIG. 1, there is shown a perspective view of a front section of a rack for holding components. The front of rack 10 has two J shaped members 12, 14 connected at their bottom to angled cross members 16 that are anchored to the floor to prevent tipping. Each J member has a wide rail 18, a narrow rail 20 and a connecting web 22. The wide rail 18 of each J member is at the front of the rack and contains a plurality of threaded openings 24 which can be evenly spaced. Each threaded opening 24 in the wide rail 18 is located from the connecting web 22 by a distance that is greater than the width of narrow rail 20. Thus, a long pin that is inserted into a threaded opening 24 can be pushed passed the edge of the narrow rail without contacting the narrow rail. Angle members 26 are attached to two vertical J shaped members (not shown) oriented to have their wide rails at the rear of the rack. The J shaped members at the rear of the rack are similar to the J shaped members 12, 14 at the front of the rack.

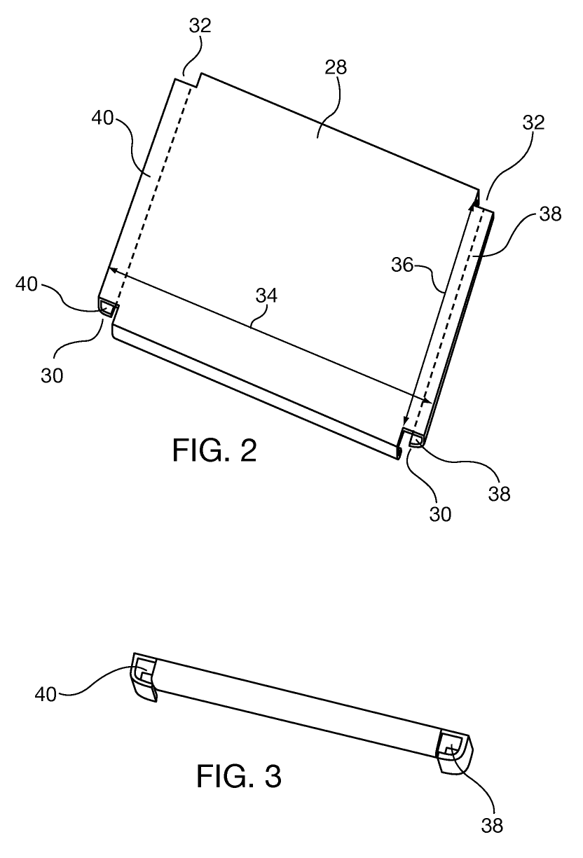

Referring to FIG. 2, there is shown a top view of support member 28. Each corner of support member 28 has a square cutout. The front two corners have cutouts 30 and the two rear corners have cutouts 32. Support member 28 has a width 34 that is slightly less that the distance between the edges of the narrow rails 12,14, and the distance 36 between the front cutouts 30 and the rear cutouts 30 are less that the distance between the wide rails at the front and rear of the rack.

Referring to FIG. 3, there is shown a front end view of the support member of FIG. 2. Support member 28 has two U shaped channels 38 and 40. One channel 38 is located along a side edge of support member 28 and extends from front cutout 30 to rear cutout 32. The other U shaped channel 40 is located along the opposite edge of support member 28 and extends from front cutout 30 to rear cutout 32. The support member is composed of aircraft grade aluminum and has U shaped channels at the front and rear. The channels add strength and rigidity to the support member.

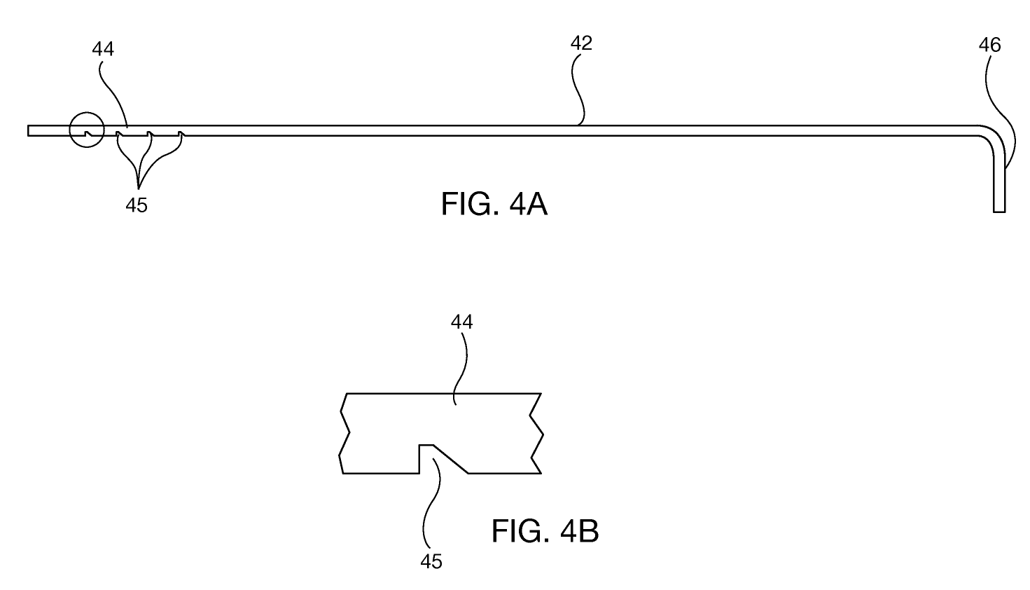

FIG. 4A shows a side view of an embodiment of an L shaped coupling pin 42. Pin 42 has a long leg 44 and a short leg 46. The long leg has a diameter of substantially ⅜ of an inch. The coupling pin has a length which is greater than the distance between the opposing J members at the front and the rear of one side of the rack 10. The short leg 46 functions as a grip when the coupling pin is being removed from the rack, as a stop to prevent the coupling pin being pushed completely through the front wide rail, and as a means for turning the coupling pin to release the notch from being engaged with the wide rail of the rear J member.

FIG. 4B shows a side view of another embodiment of an L shaped coupling pin 42. Pin 42 has a long leg 44 and a short leg 46. The long leg has a diameter of substantially ⅜ of an inch and includes a notch 45 at the end. The notch is only on one side and is sized to engage the J wide rail as it passes through an opening in the rail. Turning the coupling pin about 180 degrees releases the notch 45 from the wide rail. The coupling pin has a length which is greater than the distance between the opposing J members at the front and the rear of one side of the rack 10. The short leg 46 functions as a grip when the coupling pin is being removed from the rack, as a stop to prevent the coupling pin being pushed completely through the front wide rail, and as a means for turning the coupling pin to release the notch from being engaged with the wide rail of the rear J member.

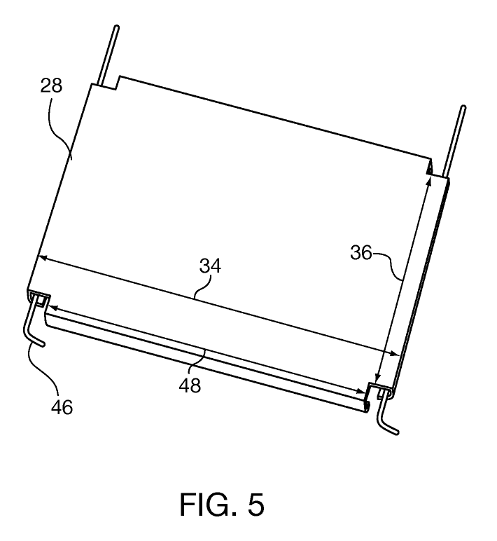

Referring to FIG. 5, there is shown the coupling pins being used to attach support member 28 to the J members of the rack. Looking at FIG. 5, the following is to be noted.

The dimension 36 between the front 30 and rear 32 cutouts is less than the distance between the wide rails of opposing front and rear J members on one side of the rack.

The dimension 34 is slightly less than the distance between the edges of the narrow rails between the J members 12, and 14 at the front of the rack and corresponding J members at the rear of the rack.

The distance 48 between the front cutouts 30 and the rear cutouts 32 is less that the distance between the edges of the wide rails of the front and rear J members of the rack.

The long legs 44 of the coupling pins 42 have a length that is greater than the distance between the wide rails of opposing front and rear J members on each side of the rack.

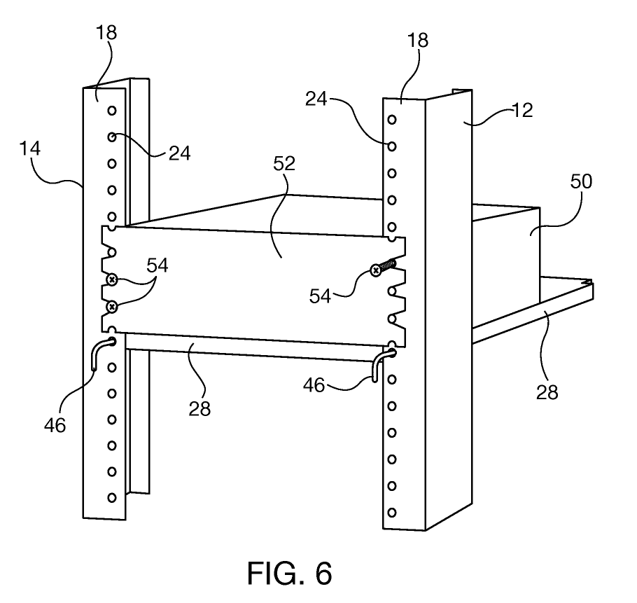

Referring to FIG. 6, there is shown a front perspective view of a component 50 resting on the support member 28 that is attached to the rack 10 with coupling pins 42 to allow a person to easily and quickly attach the component to the rack with screws.

Initially, the support member is held in front of the rack at an angle of 45 degrees, more or less, with one side edge of the support member being above the opposite side edge. While in this angled position, the support member is moved between the front J members 12, 14 and into the space between the four J members of the rack. The support member is now turned back to be in a substantially horizontal position between the four J members of the rack and is moved vertically up to align a U shaped channel, say channel 38, with a threaded opening 24 in J member 12.

It is understood that the component which is to be mounted to the rack will be placed on and be supported by support member 28. Therefore, the threaded opening 24 in the wide rail of the rack which is selected as the opening for receiving coupling pin 42 will be below the threaded opening which has been selected for receiving threaded fasteners used to attach the component to the rack.

While holding U shaped channel 38 in alignment with a selected threaded opening 24, the long leg 44 of coupling pin 42 is inserted into the threaded opening, through U shaped channel 38 and into a threaded opening in the opposite J member at the rear of the rack. At this time if the coupling pin of FIG. 4B is being used, the notch at the end of the long leg engages the wide rail of the rear J member and is locked in place.

This process is repeated with a second coupling pin being used to attach the other side of the support member to a corresponding threaded opening in J member on the other side of the rack.

Support member 28 is now firmly attached to rack 10 and will both hold and accurately position mounting plate 52 of component 50 which is to be mounted to the rack.

With the support member in place, the rear bottom of the component 50 is placed on the front top surface of support member 28 and pushed back until the rear of mounting plate 52 contacts the front of the wide rails of the J members. At this time clearance openings in mounting plate 52 are aligned with threaded openings 24 in the J members, and threaded fasteners 54 are used to firmly attach the component to the rack.

After the component is attached to the rack, the coupling pins are pulled out, and the support member is removed from the rack.

Clearly, with the support member and coupling pins here disclosed, a person can now accurately position and quickly attach heavy components to a rack with minimum effort. In a similar manner, a person can remove heavy components from a rack.

Based upon the foregoing, it will be apparent that there has been provided a new and useful device and method for attaching one or more components to a rack and for removing that component from a rack.

While there have been shown and described and pointed out the fundamental novel features of the invention as applied to the preferred embodiments, it will be understood that various omissions and substitutions and changes of the form and details of the apparatus illustrated and in the operation may be done by those skilled in the art, without departing from the spirit of the invention.

What is claimed is:

1. A device for temporarily supporting a component being attached to a rack having two front vertical corner members and two rear vertical corner members where each front corner member has openings aligned with openings in each opposing rear corner member comprising:
a support member having dimensions that allows it to be located within the space defined by said four corner members for supporting the component;
a first coupling pin adapted to be supported by a front corner member and an opposing rear corner member on one side of said rack provides support for said support member along a first side; and
a second coupling pin adapted to be supported by a front corner member and an opposing rear corner member on the other side of said rack provides support for said support member along a second opposite side.

2. The device of claim 1 for temporarily supporting a component being attached to a rack wherein said first and second coupling pins each have a long leg that is greater than the distance between said front and opposing rear corner members.

3. The device of claim 2 for temporarily supporting a component being attached to a rack wherein said long leg of said first and second coupling pins each have a diameter that is less than the diameter of aligned openings in the front and rear vertical members of said rack and are slidably received by said aligned openings.

4. The device of claim 3 for temporarily supporting a component being attached to a rack wherein said first and second coupling pins each have a short leg that is bent relative to the long leg to prevent the coupling pin from being pushed through the front vertical member.

5. The device of claim 4 for temporarily supporting a component being attached to a rack wherein said support member is of sheet metal with channels along said first side and said second opposite side.

6. The device of claim 5 for temporarily supporting a component being attached to a rack wherein said channels along said first side and said second opposite side have a U shape for receiving said coupling pins.

7. The device of claim 6 for temporarily supporting a component being attached to a rack wherein said long leg of said coupling pin supports a notch at its end adapted to releasable engage the rear corner member.

8. The device of claim 7 for temporarily supporting a component being attached to a rack wherein rotating said coupling pin releases said notch from said rear corner member.

9. The device of claim 8 for temporarily supporting a component being attached to a rack wherein front and rear ends of said support member have U shaped channels.

10. A coupling pin for holding a support member to a rack having two front vertical corner members and two rear vertical corner members where each front corner member has openings aligned with openings in each opposing rear corner member, said coupling pin comprises:
a long leg having a length that is greater than the distance between a front and opposing rear vertical member;
a first end of said long leg supports a notch on a side of the leg adapted to engage a rear corner member when said long leg is located in said aligned openings; and
a short leg coupled at an angle to a second end of said long leg.

11. A method for temporarily supporting a component having a mounting plate with clearance openings while being installed to a rack having first and second front vertical corner members and first and second rear vertical corner members where said first front member is opposite said first rear member, said second front member is opposite said second rear member, and said front corner members have openings aligned with openings in opposing rear corner member, said method comprising the steps of:
placing a support member having a first channel that extends along a first side and a second channel that extends along a second opposing side within the space defined by said four corner members for temporally supporting the component while it is being attached to the rack;
inserting a first coupling pin through an opening in said first front member, said first channel of said support member and an aligned opening in said opposing first rear member for supporting said support member along said first side; and
inserting a second coupling pin through an opening in said second front member, said second channel of said support member and an aligned opening in said opposing second rear member for supporting said support member along said second side;
wherein said support member is adapted to temporarily hold said component in position while fasteners are inserted through clearance openings in said mounting plate and aligned openings in said front vertical corner members, after which said first and second coupling pins and said temporary support member are removed from the rack.

12. The method of claim 11 for temporarily supporting a component wherein said first and second coupling pins each have a long leg that is greater than the distance between said front and opposing rear corner members.

13. The method of claim 12 for temporarily supporting a component wherein said long leg of said first and second coupling pins each have a diameter that is less than the diameter of aligned openings in the front and rear vertical members of said rack and are slidably received by said aligned openings.

14. The method of claim 13 for temporarily supporting a component wherein said first and second coupling pins each have a short leg that is bent relative to the long leg to prevent the coupling pin from being pushed through the front vertical member.

15. The method of claim 14 for temporarily supporting a component wherein said support member is of sheet metal with channels along said first side and said second opposite side.

16. The method of claim 15 for temporarily supporting a component wherein said channels along said first side and said second opposite side have a U shape for receiving said coupling pins.

17. The method of claim 16 for temporarily supporting a component wherein said long leg of said coupling pin supports a notch at its end adapted to releasable engage the rear corner member.

18. The method of claim 17 for temporarily supporting a component wherein rotating said coupling pin releases said notch from said rear corner member.

19. The method of claim 18 for temporarily supporting a component wherein front and rear ends of said support member have U shaped channels.

20. A method for holding a support member to a rack having two front vertical corner members and two rear vertical corner members where each front corner member has openings aligned with openings in each opposing rear corner member, said holding method comprises:
providing a coupling pin having a long leg with a length that is greater than the distance between a front and opposing rear vertical member;
locating a notch on a side at a first end of the long leg adapted to engage a rear corner member when said long leg is in said aligned openings; and
providing a short leg coupled at an angle to a second end of said long leg.
